(19) United States
(12) Patent Application Publication
(10) Pub. No.: US 2025/0206197 A1
(43) Pub. Date: Jun. 26, 2025

(54) SEAT ATTACHMENT STRUCTURE FOR CONNECTING A VEHICLE SEAT TO A LONGITUDINAL ADJUSTMENT MECHANISM AND/OR VEHICLE FLOOR STRUCTURE, AND VEHICLE SEAT

(71) Applicant: Adient US LLC, Plymouth, MI (US)

(72) Inventors: Tobias EWALD, Hückeswagen (DE); Martin KOZACEK, Trencín-Zlatovce (SK); Stefan SCHEHL, Dahn (DE)

(21) Appl. No.: 18/989,442

(22) Filed: Dec. 20, 2024

(30) Foreign Application Priority Data
Dec. 22, 2023 (DE) 10 2023 213 308.3
May 13, 2024 (DE) 10 2024 204 409.1

(51) Int. Cl. B60N 2/005; B60N 2/08

(52) U.S. Cl. CPC B60N 2/005; B60N 2/0868; B60N 2205/20

(57) ABSTRACT

A seat attachment structure for connecting a vehicle seat to a longitudinal adjustment mechanism and/or a vehicle floor structure is provided. The seat attachment structure has a first attachment side that is connectable to the vehicle seat and a second attachment side that is connectable to the longitudinal adjustment mechanism and/or the vehicle floor structure. The second attachment side has at least one attachment opening extending in the transverse direction with a tolerance compensation device arranged therein to compensate for tolerances in at least one spatial direction. A vehicle seat with the seat attachment structure is also provided.

### FIELD

The invention relates to a seat attachment structure for connecting a vehicle seat to a longitudinal adjustment mechanism and/or a vehicle floor structure, wherein the seat attachment structure has a first attachment side that is connectable to the vehicle seat and a second attachment side that is connectable to the longitudinal adjustment mechanism and/or the vehicle floor structure, as well as a vehicle seat.

### BACKGROUND

Seat attachment structures, for example fastening arrangements and/or seat carriers, for a seat are known in the prior art. For example, the seat can be fastened to a rail arrangement and/or a vehicle floor structure either detachably by means of hooks or screws or non-detachably by means of a welded connection.

The invention is based on the object of improving a seat attachment structure of the kind referred to above, in particular by incorporating a tolerance compensation function or a tolerance adjusting function that can be used irrespective of the tolerances coming from the structure, and providing a corresponding vehicle seat.

### SUMMARY

The aforementioned object is achieved according to the invention by a seat attachment structure having the features of claim 1. The second object is achieved according to the invention by a vehicle seat having the features of claim 10.

Developments and embodiments of the invention are the subject matter of the dependent claims.

The seat attachment structure according to the invention for connecting a vehicle seat to a longitudinal adjustment mechanism and/or a vehicle floor structure has at least one first attachment side that is connectable to the vehicle seat and a second attachment side that is connectable to the longitudinal adjustment mechanism and/or the vehicle floor structure, wherein the second attachment side comprises at least one attachment opening extending in the transverse direction with a tolerance compensation device arranged therein at least for compensation, in particular for adjusting, of tolerances in at least one spatial direction, in particular in the transverse direction, in the vertical direction, and/or in the longitudinal direction. The tolerance compensation device may, in particular, be set up to adjust transverse tolerances between the vehicle seat and the longitudinal adjustment mechanism or the vehicle seat and the vehicle floor structure.

The tolerance compensation device may, for example, comprise at least one bearing bush and/or a sleeve and two compensation elements lying opposite one another and arranged in the bearing bush or in the sleeve which, in an initial state, are each flush with a respective end face of the bearing bush and are movable from the initial state into a compensation state by means of at least one connecting element, such as a screw element. The bearing bush may be designed as a separate component, for example. For instance, an attachment carrier of the seat attachment structure can comprise two carrier sides arranged spaced apart from one another in the transverse direction, which carrier sides can be connected via a sleeve in which the bearing bush is received and held.

Alternatively, the bearing bush may be omitted and only the sleeve for receiving and storing the compensation elements provided. The bearing bush can also be designed as a sleeve, or the sleeve as a bearing bush, to connect the two carrier sides to one another.

For example, in an initial state, the compensation elements can each align flush with a respective end face of the bearing bush and/or the sleeve and are movable from the initial state into a compensation state by means of at least one connecting element.

By including at least one attachment opening extending in the transverse direction in the second attachment side, with a tolerance compensation device arranged therein, a tolerance-related gap, such as an assembly gap, between the seat attachment structure and the longitudinal adjustment mechanism and/or the vehicle floor structure can be bridged, in particular compensated or adjusted, in a simple and uncomplicated manner.

Advantageous embodiments that can be used individually or in combination with one another are the subject of the dependent claims.

The tolerance compensation device may be a separate adapter or a separate adapter module. The tolerance compensation device can easily be integrated into existing seat attachment structures.

For example, the respective compensation element may be configured as a sliding element. In this case, the attachment opening may have dimensions that are larger than the dimensions of the compensation element, in particular of the sliding element. The respective compensation element can also be pre-installable or is pre-installed loosely within the bearing bush and/or sleeve. In particular, the respective compensation element can, for example, be arranged in a self-centering manner in the bearing bush and/or the sleeve. In other words, the seat attachment structure with the tolerance compensation device can be designed as a self-centering connector with tolerance adjustment in at least one spatial direction, in particular perpendicular to the connection direction, in the connection direction, and/or radially to the attachment opening. This enables remaining tolerances during assembly to be easily adjusted and/or the vehicle seat to be aligned relative to the longitudinal adjustment mechanism and/or the vehicle floor structure.

For example, for connection to the vehicle seat, the seat attachment structure may comprise at least one attachment carrier. The respective attachment carrier may, for example, have two seat mounting attachment surfaces arranged parallel to one another. An attachment carrier can be provided for each rail arrangement (also referred to as a rail pair with an upper rail and a lower rail),

For connection to the longitudinal adjustment mechanism and/or to the vehicle floor structure, the seat attachment structure may comprise at least one fastening structure. The fastening structure may have, for example, two rail mounting attachment surfaces arranged parallel to one another. For each rail arrangement, a fastening structure can be provided.

The vehicle seat may be a single seat and/or a bench seat, for example. For seating applications, such as in the second or third row of a vehicle, for example, vehicle structures are conventionally equipped with rails, for example two rails (in particular, two rail arrangements or two rail pairs, each with an upper rail and a lower rail) per seat and/or bench seat, to allow a seat adjustment in the longitudinal direction, such as for comfort adjustment and/or easy-entry access. To increase the required load capacities of the rails, it may be necessary to distribute a load over more than two rails. For example, many vehicle structures are provided with more than two rails. For example, four rails can be provided for a full bench seat, which can overload an overall system, for example due to alignment errors, tolerance errors, and/or play errors between the seat and longitudinal adjustment mechanism and/or vehicle body, wherein errors of this kind can potentially lead to unwanted jamming and/or disturbing noises during adjustment.

The tolerance compensation device is provided in order to reduce, in particular to eliminate, errors. The implementation of tolerance compensation or tolerance adjusting between the seat attachment structure and the rails of a longitudinal adjustment mechanism and/or the fastening structures of a vehicle floor structure enables overloads to be eliminated.

For example, middle rails (also referred to as rail arrangements) or tracks can be easily connected to the seat attachment structure. The second attachment side can be configured as a fastening arm and/or seat carrier. The second attachment side can be designed to connect the vehicle seat to a middle rail/rail arrangement in a longitudinal adjustment mechanism with more than two rails/rail arrangements. The second attachment side can serve as an interface to the rails.

Furthermore, the invention relates to a vehicle seat with a previously described seat attachment structure.

In summary, and in other words, the invention provides a seat attachment structure with a tolerance compensation function or tolerance adjusting function, wherein the tolerance compensation device comprises at least two compensation elements designed as sliding elements, in particular as adapters, which are installed, in particular pre-installed, in a bearing bush within the seat attachment structure. The compensation elements can be moved relative to one another in at least the transverse direction (Y-direction), alternatively or in addition in the longitudinal direction, vertical direction, and/or radially, and can independently find their position, in particular a compensation position, based on tolerances of the seat attachment structure relative to pre-installed rails and/or floor fastening elements in the vehicle.

### DESCRIPTION OF THE FIGURES

The invention is explained in greater detail below with reference to advantageous exemplary embodiments depicted in the figures. The invention is not limited to these embodiments, however. In the drawings:

FIG. 1: shows a schematic representation of a vehicle seat with a longitudinal adjustment mechanism according to the prior art,

FIG. 2: shows a perspective view of a vehicle seat, in particular a vehicle bench seat, fastened to a longitudinal adjustment mechanism,

FIG. 3: shows schematically an exploded view of a seat attachment structure according to the invention for connecting a vehicle seat to a longitudinal adjustment mechanism and/or a vehicle floor structure,

FIGS. 4 to 6: show schematically in perspective views, an assembly process for installing a tolerance compensation device into a seat attachment structure,

FIG. 7: shows schematically in side view a vehicle seat with a seat attachment structure arranged on a longitudinal adjustment mechanism,

FIGS. 8 to 11: show schematically in sectional views a fastening process for fastening a vehicle seat to a longitudinal adjustment mechanism, and

FIGS. 12 to 15: show schematically in front views another fastening process for fastening a vehicle seat to a longitudinal adjustment mechanism.

### DETAILED DESCRIPTION

Parts that correspond to one another are labeled with the same reference signs in all figures.

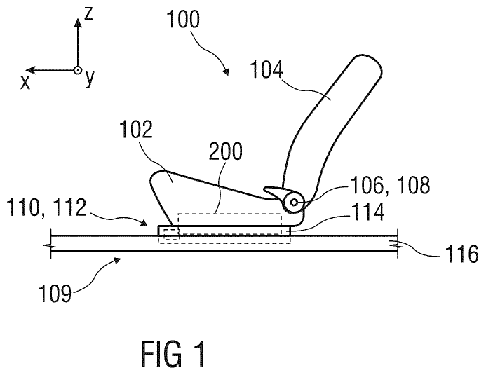

A vehicle seat 100 shown schematically in FIG. 1 as the prior art is described below using three spatial directions running perpendicularly to one another. A longitudinal direction x runs largely horizontally and preferably parallel to a longitudinal axis of the vehicle, which corresponds to the customary direction of travel of the vehicle, when the vehicle seat 100 is installed in the vehicle. A transverse direction y, perpendicular to the longitudinal direction x, is also aligned horizontally in the vehicle and runs parallel to a vehicle transverse axis. A vertical direction z runs perpendicular to the longitudinal direction x and perpendicular to the transverse direction y. In the case of a vehicle seat 100 installed in the vehicle, the vertical direction z preferably runs parallel to a vertical axis of the vehicle.

The positional and directional references used, such as front, rear, top, and bottom, for example, are based on a perspective of a passenger seated in the vehicle seat 100 in a normal seating position, wherein the vehicle seat 100 is installed in the vehicle in an operational position suitable for passenger transport, with the backrest 104 upright and oriented, as customary, in the direction of travel. However, the vehicle seat 100 may also be installed or moved in a different orientation, for example transversely to the direction of travel. Unless otherwise specified, the vehicle seat 100 is designed to be mirror-symmetrical to a plane running perpendicular to the transverse direction y.

The backrest 104 may be pivotably arranged on a seat part 102 of the vehicle seat 100. For this purpose, the vehicle seat 100 may optionally comprise a fitting 106, in particular an adjustment fitting, pivot fitting, locking fitting, or tilting fitting.

The positional and directional references used, such as radial, axial, and in the circumferential direction, for example, relate to a rotational axis 108 of the fitting 106. Radial means perpendicular to the rotational axis 108. Axial means in the direction of, or parallel to, the rotational axis 108.

The vehicle seat 100 may optionally comprise a longitudinal adjustment mechanism 110. The longitudinal adjustment mechanism 110 comprises, for example, a rail arrangement 112 with a first rail element 114 and a second rail element 116. The first rail element 114 is adjustable relative to the second rail element 116 in the longitudinal direction x. The first rail element 114 is fastened to the seat part 102. The second rail element 116 is fastened to a structural component of a vehicle, for example a vehicle floor.

For greater clarity, the first rail element 114 is referred to as the upper rail 114 in the description below. This upper rail 114 (also called a slide rail or carriage) is associated with the vehicle seat 100 and set up to support this vehicle seat 100. The second rail element 116 is referred to below as the lower rail 116. The lower rail 116 is fixedly connected, for example, to the floor of a vehicle.

The vehicle seat 100 may comprise, in particular, two rail arrangements 112 arranged parallel to one another as the longitudinal adjustment mechanism 110. The two rail arrangements 112, each designed as a rail pair, for example, are arranged spaced apart and parallel to one another. The two rail pairs may be substantially identical in structure and correspond to one another in terms of structure and function, unless described otherwise below.

To connect the vehicle seat 100 to the longitudinal adjustment mechanism 110 and/or a vehicle floor structure 109, the vehicle seat 100 may be provided with a seat attachment structure 200, for example a seat carrier structure. The seat attachment structure 200 is arranged between the vehicle seat 100 and the longitudinal adjustment mechanism 110 and/or the vehicle floor structure 109 (also referred to as the vehicle floor) and serves to connect the vehicle seat 100, in particular the seat part 102, to the longitudinal adjustment mechanism 110 and/or the vehicle floor structure 109.

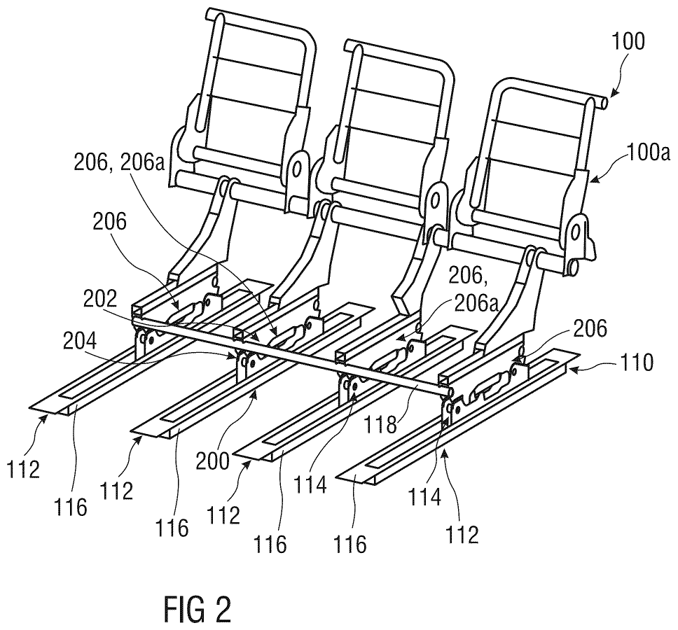

FIG. 2 shows a perspective view of a vehicle seat 100, in particular a vehicle bench seat 100a, fastened to a longitudinal adjustment mechanism 110. The term vehicle seat 100 should be understood to mean, in particular, a multi-part seat with multiple seating surfaces viewed in the transverse direction y.

The longitudinal adjustment mechanism 110 shown here comprises four rail arrangements 112, in particular rail pairs. The longitudinal adjustment mechanism 110 may also comprise only two rail arrangements 112 or three, or more than four rail arrangements 112 which are arranged parallel to one another. The rail arrangements 112 extend in the longitudinal direction x of the vehicle seat 100.

Each rail arrangement 112 or each rail pair comprises the lower rail 116, which may be integrated into a floor of a vehicle, for example, and the upper rail 114, which is mounted in a longitudinally movable manner within the lower rail 116.

The seat attachment structure 200 comprises, at least on one of the rail arrangements 112, a first attachment side 202 that is connectable to the vehicle seat 100, and a second attachment side 204 that is connectable to the longitudinal adjustment mechanism 110 and/or a vehicle floor structure not depicted in greater detail. For example, the seat attachment structure 200 comprises two lateral attachment carriers 206, each with a first attachment side 202 and a second attachment side 204. Each rail arrangement 112 in this case may be associated with an attachment carrier 206.

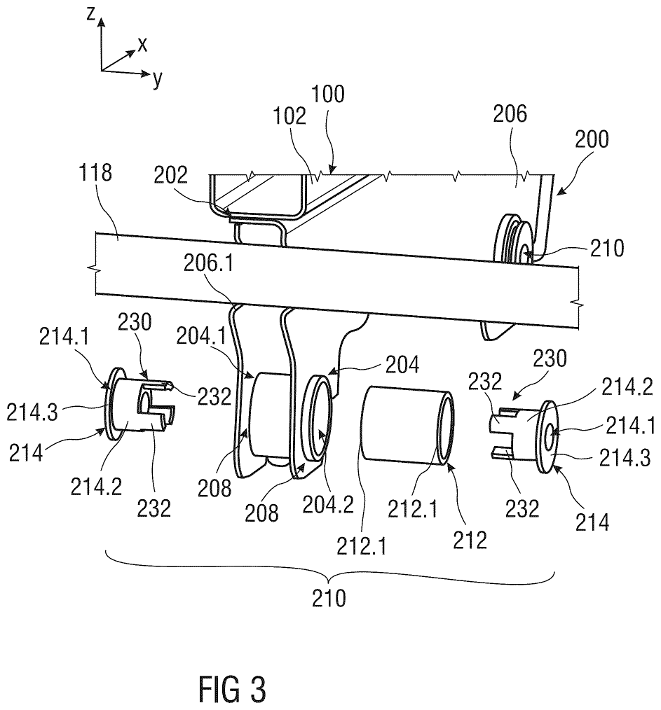

In the case of a first bench seat 100a, at least inner, or internally located, attachment carriers 206a may each be provided with at least one tolerance compensation device 210, also referred to as a tolerance adjusting device, shown in greater detail in FIG. 3, to improve a connection or fastening of the vehicle seat 100 or bench seat 100a to the longitudinal adjustment mechanism 110 and/or the vehicle floor structure 109.

The seat attachment structure 200 can be designed as an adapter or adapter module. In particular, the seat attachment structure 200 may be designed as a separate component or a separate pre-assemblable, multi-part module. The seat attachment structure 200 is used, on the one hand, as an interface to the respective rail arrangement 112 and, on the other hand, as an interface to the vehicle seat 100, in particular to the respective seat part 102 (as shown in FIG. 1).

The attachment carriers 206 of all rail arrangements 112 for the vehicle seat 100 designed as a bench seat 100a can be rigidly connected to one another by means of a cross-member 118.

FIG. 3 shows schematically an exploded view of the seat attachment structure 200 according to the invention for connecting a vehicle seat 100 to the longitudinal adjustment mechanism 110 and/or a vehicle floor structure not shown in greater detail.

The attachment carrier 206 of the seat attachment structure 200 may have two carrier sides 208 arranged spaced apart from one another in the transverse direction y. The carrier sides 208 are plate-shaped. The carrier sides 208 are, in particular, designed as identical parts. Alternatively, the attachment carrier 206 may be in the form of a one-piece, in particular a U-shaped, carrier block with two leg surfaces forming the carrier sides 208.

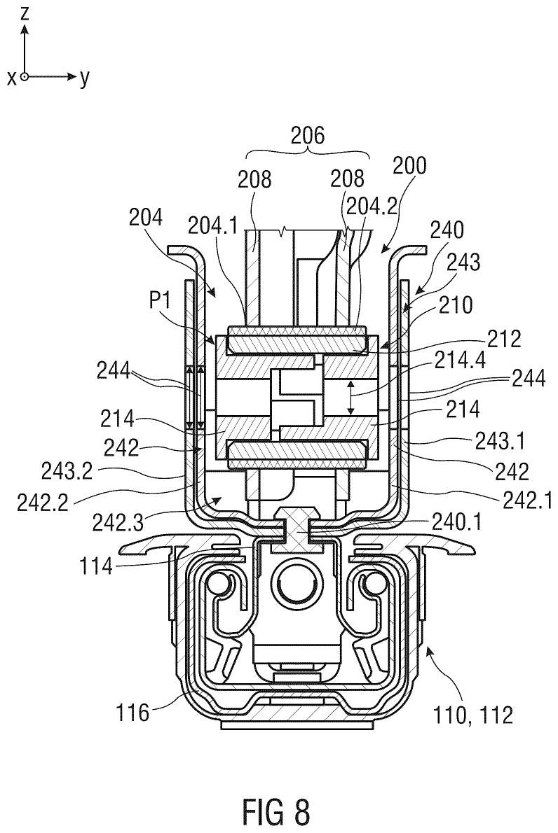

The attachment carrier 206 may be designed as an adapter or adapter module. The attachment carrier 206 forms a fastening interface to the seat part 102, on the one hand, and to the rail arrangement 112, on the other hand (as shown in FIG. 8).

The attachment carrier 206 comprises a first attachment side 202 connectable to the vehicle seat 100 and a second attachment side 204 connectable to the rail arrangement 112 and/or a vehicle floor structure not depicted in greater detail.

The second attachment side 204 is equipped with at least one tolerance compensation device 210. For this purpose, the second attachment side 204 has at least one attachment opening 204.1 extending in the transverse direction y, in particular a through-hole, with a tolerance compensation device 210 arranged therein at least to compensate for tolerances in at least one spatial direction, in particular to adjust transverse tolerances.

In one development, the carrier sides 208 may each feature an attachment opening 204.1, wherein the attachment openings 204.1 are aligned in the transverse direction y flush with one another.

A sleeve 204.2, for example a metal sleeve, is arranged and fixed in the attachment opening 204.1. The sleeve 204.2 can be connected to the attachment opening 204.1 at least by a form fit, force fit, and/or material bond. The sleeve 204.2 may project beyond the respective attachment opening 204.1 viewed in the transverse direction y. Alternatively, the sleeve 204.2 may end flush with the attachment openings 204.1 (not illustrated).

The tolerance compensation device 210 comprises at least one bearing bush 212, for example a bearing sleeve, and two compensation elements 214 that are arrangeable, or are arranged, within the bearing bush 212 opposite one another.

The bearing bush 212 may be a plastic sleeve. The bearing bush 212 is insertable, or inserted, into the sleeve 204.2. The bearing bush 212 can be connected to the sleeve 204.2 by a form fit, force fit, and/or material bond.

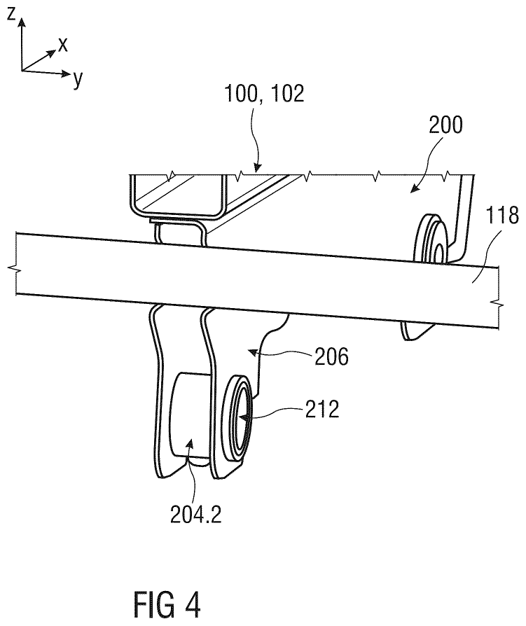

In an alternative configuration not shown in greater detail, the bearing bush 212 can be omitted. In this embodiment which is not illustrated, the sleeve 204.2 directly forms the bearing arrangement for the compensation elements 214. In this embodiment, the compensation elements 214 are then arranged and held directly in the sleeve 204.2. In other words, in this embodiment which is not shown in greater detail, only a single sleeve formed by the sleeve 204.2, rather than a double sleeve formed by the sleeve 204.2 and bearing bush 212, as depicted in FIGS. 3 and 4, is provided between the carrier sides 208. The description of the arrangement and bearing of the compensation elements 214 in the bearing bush 212 applies analogously to the direct arrangement and bearing of the compensation element 214 in the sleeve 204.2.

The compensation elements 214 may be designed as compensation adapters or compensation adapter elements. The compensation elements 214 may be hollow cylindrical adjusting elements. The compensation elements 214 may be designed as sliding bushes or sliding sleeves.

Each compensation element 214 comprises an internal thread 214.1. The compensation elements 214 each comprise a hollow cylindrical base body 214.2 and a flange section 214.3 arranged on the end face of the base body 214.2. The flange section 214.3 may have a larger diameter than the base body 214.2. The flange section 214.3 may form a contact section, in particular a flat contact surface, to support against a fastening element 242 of the rail arrangement 112 and/or the vehicle floor structure not depicted in greater detail.

The cross-member 118 is positioned between the first attachment side 202 and the second attachment side 204 on the attachment carrier 206. In particular, the cross-member 118 is arranged and secured in an offset 206.1 at the end face of the attachment carrier 206. For example, the cross-member 118 is connected to the attachment carrier 206 in the region of the offset 206.1 by a form fit, force fit, and/or material bond.

The first attachment side 202 may, for example, be designed as a form-fit, force-fit, or material-bond connection between the attachment carrier 206 and the seat part 102, in particular a frame structure, a shell structure, or similar. For example, the attachment carrier 206 can be connected to the seat part 102 in the region of the first attachment side 202 using screws, welding, or similar methods.

FIG. 4 shows the seat attachment structure 200 in a preassembled state on the seat part 102 and with the sleeve 204.2 arranged in the attachment openings 204.1 of the attachment carrier 206 and the bearing bush 212 arranged in the sleeve 204.2 and with the cross-member 118 arranged on the attachment carrier 206.

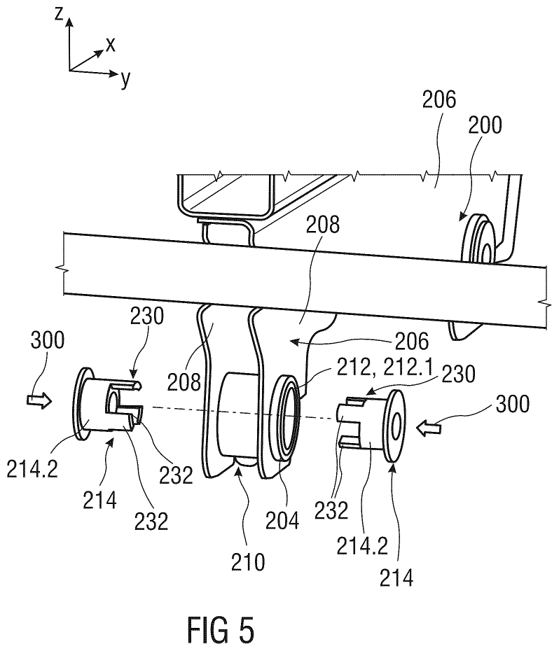

FIG. 5 shows the insertion or sliding of the compensation elements 214 into the bearing bush 212 along the transverse direction y, as indicated by arrow 300. The compensation elements 214 are aligned in respect of one another in such a manner that the securing elements 232 of the anti-rotation feature 230 interlock appropriately.

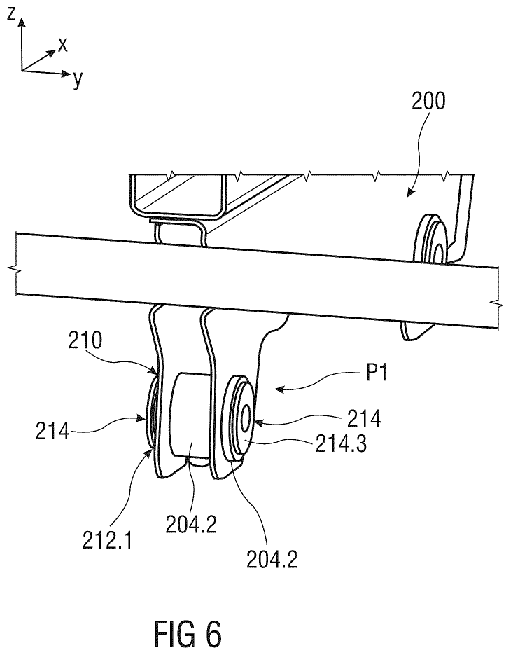

FIG. 6 shows a fully assembled tolerance compensation device 210 (initial state P1), wherein the compensation elements 214 end flush with the end faces 212.1 of the bearing bush 212 and/or the sleeve 204.2. Alternatively, the bearing bush 212 and/or sleeve 204.2 may each have a flange that rests externally on the carrier sides 208.

In an initial state P1 shown in greater detail in FIG. 6, the compensation elements 214 each end flush with a respective end face 212.1 of the bearing bush 212 and/or a respective end face of the sleeve 204.2.

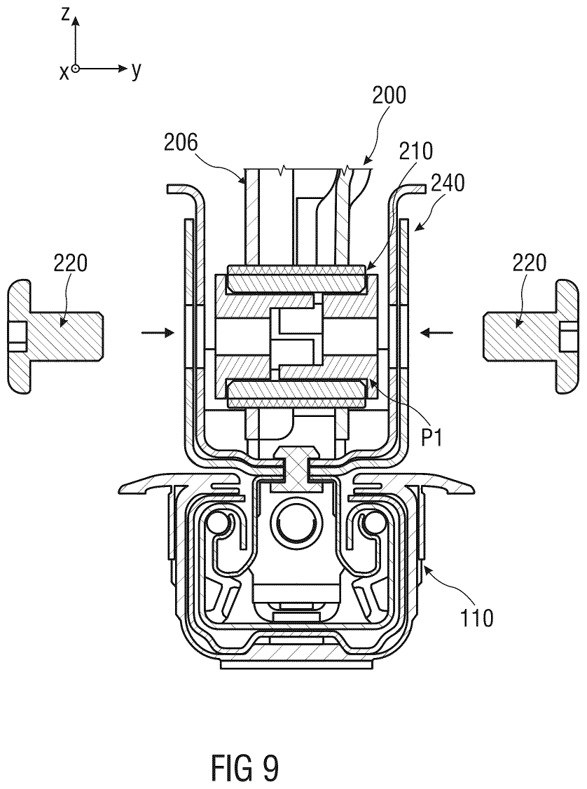

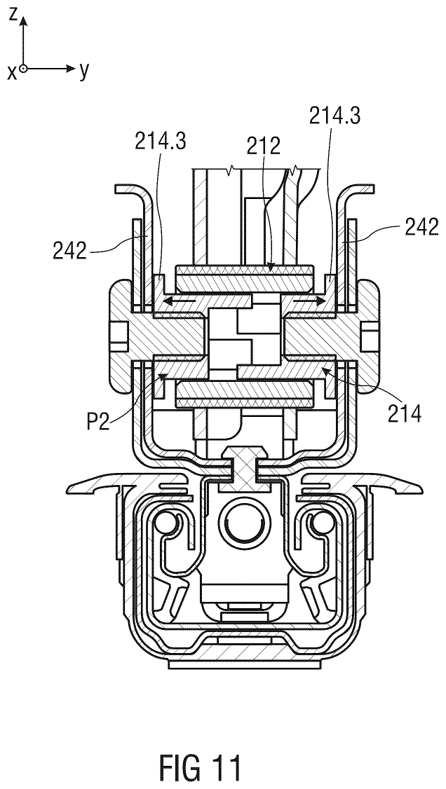

In particular, the compensation elements 214 are each inserted or pushed far enough into the bearing bush 212 that an inner surface of the respective flange section 214.3 is in contact with the respective end face 212.1 of the bearing bush 212. Using at least one connecting element 220, depicted in greater detail in FIGS. 9 to 11, such as a screw element, the compensation elements 214 can be moved from the initial state P1 (shown in FIG. 9) to a compensation state P2 (illustrated in FIG. 11), in particular for tolerance compensation or tolerance adjustment.

To prevent the compensation elements 214 from rotating during the screwing-in of the connecting element 220, the compensation elements 214 may each have an anti-rotation mechanism 230 at their facing ends (shown in FIG. 5). The anti-rotation mechanism 230 provides an “anti-rotation function”. The anti-rotation mechanism 230 is set up to prevent the compensation elements 214 from rotating against one another while the connecting element 220, in particular a screw, is tightened. For example, a connecting element 220 is used on both sides of the tolerance compensation device 210, engaging with a respective compensation element 214, in particularly in threaded engagement.

The anti-rotation mechanism 230 comprises a number of corresponding securing elements 232, for example locking arms, locking tabs, locking hooks, and/or locking grooves. The securing elements 232 are each located on opposite facing ends of the compensation elements 214. The securing elements 232 can be integrally formed with the respective base body 214.2 of the compensation element 214 (illustrated in FIG. 5).

In the initial state P1 (shown in FIG. 6), when both compensation elements 214 are completely arranged within the bearing bush 212, the securing elements 232 can be interlocked in such a manner that the compensation elements 214 are braced against one another and prevented from rotating.

FIGS. 4 to 6 show schematically in perspective views an assembly process for assembling a tolerance compensation device 210 in a seat attachment structure 200.

FIG. 4 shows the bearing bush 212 preassembled in the sleeve 204.2 of the attachment carrier 206. The bearing bush 212 can be pressed into the sleeve 204.2. The bearing bush 212 is arranged and held in the sleeve 204.2 by a form fit and/or a force fit.

FIG. 5 shows an insertion on both sides or sliding on both sides of the compensation elements 214 into the bearing bush 212 in the transverse direction y, as indicated by arrows 300. The compensation elements 214 are aligned with one another in such a manner that the securing elements 232 of the anti-rotation mechanism 230 interlock properly. The bearing bush 212 is arranged on the attachment carrier 206, passing through the two carrier sides 208. The end faces of the sleeve 204 and the end faces 212.1 of the bearing bush 212 are flush with one another.

FIG. 6 shows a fully assembled tolerance compensation device 210 (initial state P1), wherein the compensation elements 214, in particular the angled collar or outer flange sections 214.3 thereof, resting on the end faces 212.1 (depicted in FIG. 5) of the bearing bush 212 and/or the ends of the sleeve 204.2 on the end faces.

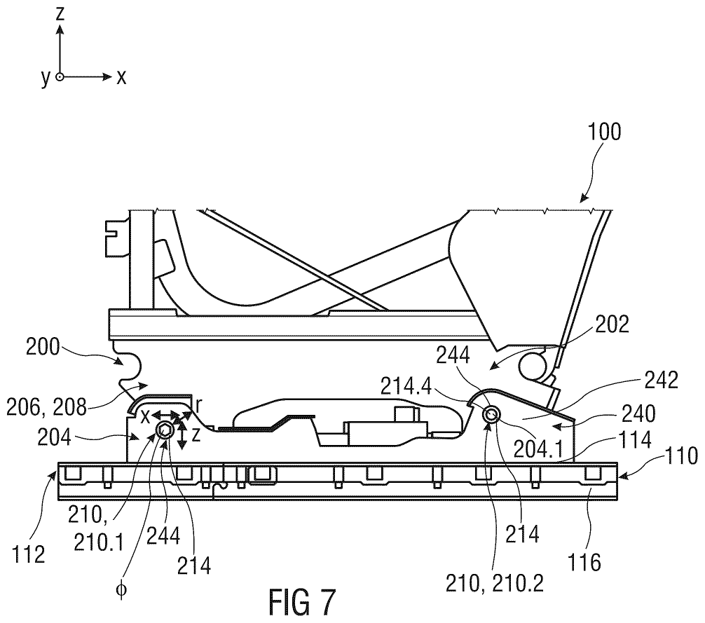

FIG. 7 shows schematically a side view of the vehicle seat 100 arranged on the longitudinal adjustment mechanism 110 with the seat attachment structure 200. As previously described with the help of FIGS. 5 and 6, the seat attachment structure 200 comprises the two carrier sides 208 (only one carrier side 208 of which is shown in FIG. 7) of the attachment carrier 206 as the first attachment side 202.

As the second attachment side 204, the seat attachment structure 200 comprises at least one fastening structure 240 with at least one fastening element 242.

The at least one fastening structure 240 is used to fasten the seat attachment structure 200 to the longitudinal adjustment mechanism 110. For example, the fastening structure 240 may be connected to the rail arrangement 112, in particular to the upper rail 114. Alternatively, the fastening structure 240 may be set up to fasten the vehicle seat 100 to a vehicle floor not depicted in greater detail and create a suitable vehicle floor structure.

The tolerance compensation device 210 is provided to compensate for tolerances between the attachment carrier 206 of the vehicle seat 100 and the fastening structure 240 of the longitudinal adjustment mechanism 110.

The tolerance compensation device 210 is particularly arranged in the region of the second attachment side 204 of the seat attachment structure 200 (as shown in detail in FIG. 8).

For tolerance compensation, two tolerance compensation devices 210 can be provided, in particular a first tolerance compensation device 210.1 in a front region of the seat attachment structure 200 and a second tolerance compensation device 210.2 in a rear region of the seat attachment structure 200.

The attachment carrier 206, in particular the attachment opening 204.1 thereof, the fastening structure 240, in particular the fastening opening 244 thereof, and the tolerance compensation device 210, in particular a through-hole 214.4, are set up and aligned in such a manner that a connecting element 220 is insertable on both sides of the seat attachment structure 200 (as shown in FIGS. 8 to 11) into the tolerance compensation device 210, in particular into the associated compensation elements 214, to connect the attachment carrier 206 and the fastening structure 240. In this case, by means of the tolerance compensation device 210 arranged between the attachment carrier 206 and the fastening structure 240, tolerances in at least one spatial direction, in particular in the longitudinal direction x, vertical direction z, transverse direction y, and/or radial direction r, can be adjusted.

The through-hole 214.4 of the respective compensation element 214 is, in particular, smaller than the attachment openings 204.1 and smaller than the fastening openings 244. The attachment openings 204.1 are larger than the through-hole 214.4 and smaller than the fastening openings 244.

FIG. 8 shows the seat attachment structure 200 with the attachment carrier 206 arranged between two fastening elements 242 of the fastening structure 240, which attachment carrier 206 in turn has two carrier sides 208 (also referred to as carrier plates or carrier surfaces) with the attachment opening 204.1 for receiving the tolerance compensation device 210.

The fastening structure 240 may have at least the two fastening elements 242 arranged spaced apart from one another in the transverse direction y, for example two separate fastening plates arranged parallel to one another or two fastening arms 242.1, 242.2 of a one-piece, U-shaped fastening element 242. The seat attachment structure 200, in particular the attachment carrier 206, is arranged in an intermediate space 242.3, in particular a receiving space or hollow space, formed between the two fastening arms 242.1, 242.2.

The fastening elements 242, in particular the two fastening arms 242.1, 242.2, may each have two fastening openings 244 aligned with one another in the transverse direction y for the insertion of connecting elements 220, in particular screw elements. The fastening openings 244 can each be “oversized”. The fastening openings 244 can be larger in the radial direction r, vertical direction z, and/or longitudinal direction x than a hollow space, in particular the through-hole 214.4, of the respective compensation element 214, in order to allow for a tolerance adjustment or a tolerance compensation in the radial direction r, y-direction, x-direction, and/or z-direction. “Oversized” fastening openings 244 of this kind allow a tension-free and aligned positioning of the seat attachment structure 200, in particular of the attachment carrier 206 and the fastening structure 240 relative to one another, and by means of the tolerance adjustment device 210, a compensating positioning of the attachment carrier 206 and the fastening structure 240 relative to one another in the radial direction r, y-direction, x-direction, and/or z-direction. In this way, rattling noises during an adjustment of the vehicle seat 100 can be largely reduced or even eliminated.

FIGS. 8 to 11 schematically depict a fastening process for connecting a vehicle seat 100 to a longitudinal adjustment mechanism 110.

FIG. 8 shows the seat attachment structure 200 arranged between the fastening elements 242 of the fastening structure 240, wherein the tolerance compensation device 210 is aligned relative to the fastening openings 244 of the respective fastening element 242. A gap or play may exist between the fastening structure 240 and the seat attachment structure 200 in this case in the radial direction r, x-direction, y-direction, and/or z-direction. The seat attachment structure 200 and the fastening structure 240 do not require tension, for example preloading, relative to one another. The respective tolerance compensation device 210 is provided for this purpose.

The fastening structure 240 can be fastened, for example, to the first rail element 114, for example to an upper rail.

In particular, the fastening structure 240 can be connected to the upper rail 114 by means of a fastening 240.1, for example a rivet connection, a screw connection, a welded connection, or similar.

To enhance the strength and stiffness, the fastening structure 240 may comprise an additional fastening element 243, in particular another U-shaped fastening element 243 with fastening arms 243.1, 243.2. The two fastening elements 242, 243 are designed to correspond to one another, in such a manner that they are, for example, inserted into one another and connected in a form-fitting and/or force-fitting manner, in particular through frictional engagement, and, in addition, are connected to one another and to the upper rail 114 via the fastening 240.1. The fastening element 242 (also referred to as the inner fastening element 242) provides inner contact surfaces for the compensation elements 214. The other fastening element 243 (also referred to as the outer fastening element 243) provides outer contact surfaces for the connecting elements 220. The two fastening elements 242, 243 can be either separate or integrally formed.

FIG. 9 shows the placement of connecting elements 220 on both sides of the fastening structure 240, wherein each compensation element 214 has an associated connecting element 220. The respective connecting element 220 may be a locking screw.

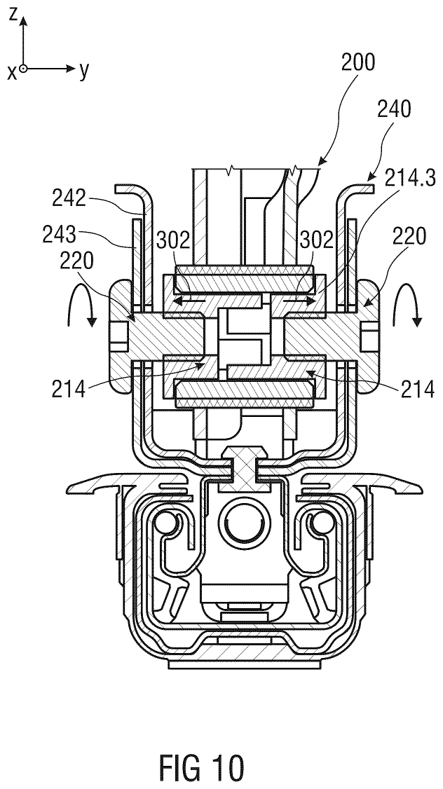

FIG. 10 shows the initial tightening of the respective connecting element 220. The respective compensation element 214 is moved out of the bearing bush 212 in the transverse direction y by rotating the connecting element 220, as indicated by arrows 302, until the flange section 214.3 comes into contact with the inner contact surface, particularly with the inner fastening element 242, and is thereby braced in the transverse direction y.

A geometry of the anti-rotation mechanism 230 prevents rotation during tightening and the application of a torque via the connecting elements 220. The compensation elements 214, in particular the securing elements 232, come into contact and support one another to prevent rotation. While this occurs, the compensation elements 214 continue to move outwards in the transverse direction y, particularly until a final position, in particular the compensation state P2, has been reached.

FIG. 11 shows the tolerance compensation device 210 in the compensation state P2, with the compensation elements 214 arranged in the bearing bush 212 and their flange sections 214.3 resting against the inner fastening element 242 to compensate for transverse tolerances in the transverse direction y. The seat attachment structure 200 is now connected in a torsion-free or torsionless manner to the fastening structure 240, wherein the tolerances that may arise from structural elements can be eliminated.

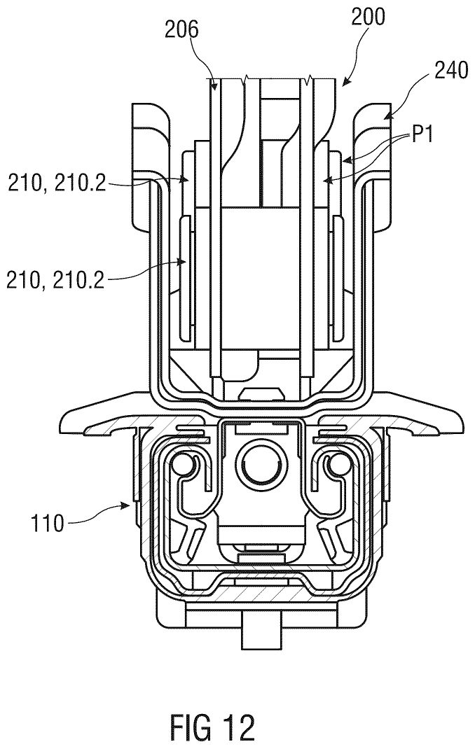

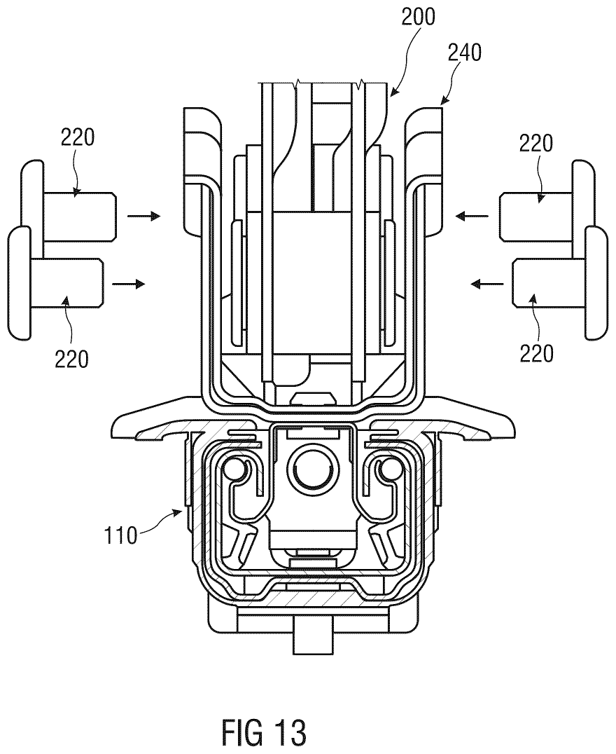

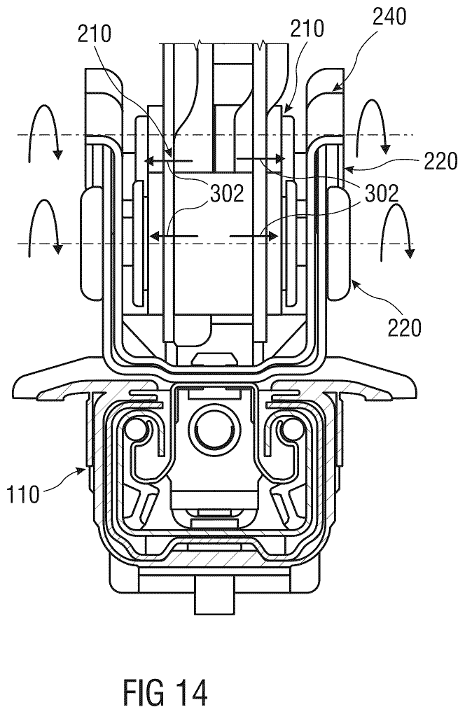

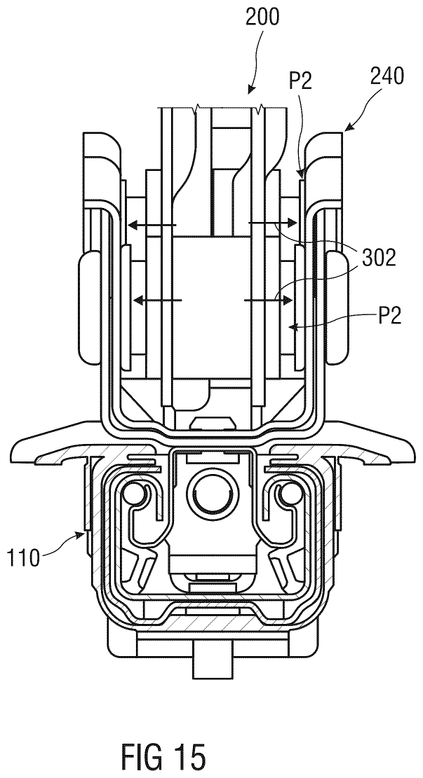

FIGS. 12 to 15 show schematically, in front views, another fastening process for fastening the vehicle seat 100 to the longitudinal adjustment mechanism 110, in particular via the seat attachment structure 200, by which the two tolerance compensation devices 210.1 and 210.2, with the components to be connected-the attachment carrier 206 and the fastening structure 240-in the initial state P1, using the two tolerance compensation devices 210.1, 210.2, which are identically designed and constructed as described previously.

The fastening process shown in FIGS. 12 to 15 follows the same method as the fastening process described in FIGS. 8 to 11, with the seat attachment structure 200 potentially having multiple tolerance compensation devices 210, which can be tightened simultaneously or at the same time using connecting elements 220.

### LIST OF REFERENCE SIGNS

100 Vehicle seat
100a Vehicle bench seat
102 Seat part
104 Backrest
106 Fitting
108 Rotational axis
109 Vehicle floor structure
110 Longitudinal adjustment mechanism
112 Rail arrangement
114 First rail element (upper rail)
116 Second rail element (lower rail)
118 Cross-member
200 Seat attachment structure
202 First attachment side
204 Second attachment side
204.1 Attachment opening
204.2 Sleeve
206 Attachment carrier
206a Inner attachment carrier
206.1 Offset
208 Carrier side
210 Tolerance compensation device
210.1 First tolerance compensation device
210.2 Second tolerance compensation device
212 Bearing bush
212.1 End face
214 Compensation element
214.1 Internal thread
214.2 Base body
214.3 Flange section
214.4 Through-hole
220 Connecting element
230 Anti-rotation mechanism
322 Securing element
240 Fastening structure
240.1 Fastening
242 Fastening element
242.1, 242.2 Fastening arm
242.3 Intermediate space
243 Additional fastening element
243.1, 243.2 Fastening arm
244 Fastening opening
300 Arrow
302 Arrow
P1 Initial state
P2 Compensation state
r Radial direction
x Longitudinal direction
y Transverse direction
z Vertical direction

What is claimed is:

1. A seat attachment structure for connecting a vehicle seat to at least one of a longitudinal adjustment mechanism and a vehicle floor structure,
wherein the seat attachment structure has a first attachment side that is connectable to the vehicle seat and a second attachment side that is connectable to at least one of the longitudinal adjustment mechanism and the vehicle floor structure,
wherein the second attachment side has at least one attachment opening extending in the transverse direction with a tolerance compensation device arranged therein at least for compensation of tolerances in at least one spatial direction.

2. The seat attachment structure as claimed in claim 1, wherein the tolerance compensation device is configured as a separate adapter that is arrangeable, or is arranged, in the attachment opening.

3. The seat attachment structure as claimed in claim 1, wherein the tolerance compensation device comprises at least one bearing bush and two compensation elements lying opposite one another and arranged in the bearing bush.

4. The seat attachment structure as claimed in claim 3, wherein the compensation elements in an initial state are each flush with a respective end face of the bearing bush and is movable from the initial state into a compensation state by means of at least one connecting element.

5. The seat attachment structure as claimed in claim 3, wherein the respective compensation element is pre-installable or is pre-installed loosely within the bearing bush.

6. The seat attachment structure as claimed in claim 3, wherein the respective compensation element is arranged in a self-centering manner in the bearing bush.

7. The seat attachment structure as claimed in claim 1, wherein the tolerance compensation device comprises at least one sleeve and two compensation elements arranged within the sleeve opposite one another.

8. The seat attachment structure as claimed in claim 7, wherein the compensation elements in an initial state are each flush with a respective end face of the sleeve and is movable from the initial state into a compensation state by means of at least one connecting element.

9. The seat attachment structure as claimed in claim 3, wherein the respective compensation element is configured as a sliding element.

10. The seat attachment structure as claimed in claim 7, wherein the respective compensation element is pre-installable or is pre-installed loosely within the sleeve.

11. The seat attachment structure as claimed in claim 3, wherein the respective compensation element is arranged in a self-centering manner in the sleeve.

12. The seat attachment structure as claimed in claim 1, comprising at least one attachment carrier that has two carrier sides for connection to the vehicle seat.

13. The seat attachment structure as claimed in claim 1, comprising at least one fastening structure with two fastening elements arranged parallel to one another for connection to at least one of the longitudinal adjustment mechanism and to the vehicle floor structure.

14. A vehicle seat with a seat attachment structure as claimed in claim 1.
